(19) United States
(12) Patent Application Publication
(10) Pub. No.: US 2005/0276605 A1
(43) Pub. Date: Dec. 15, 2005

(54) Method of upgrading an optical transmission network, an optical transmission network, and associated optical transmission nodes

(75) Inventors: Franck Pain, Saint Michel Sur Orge (FR); Jean-Paul Faure, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/129,410

(22) Filed: May 16, 2005

(30) Foreign Application Priority Data
Jun. 14, 2004 (FR) 04 51 168

(51) Int. Cl. H04J 14/02

(52) U.S. Cl. 398/79

(57) ABSTRACT

The invention relates to methods of upgrading optical transmission networks, upgradeable optical transmission networks, and upgradeable optical transmission nodes. The node of the invention is an upgradeable optical transmission node comprising a plurality of optical fiber transmission lines, a plurality of optical splitters (2) each having one input optical fiber transmission line (20) and a plurality of output optical fiber transmission lines (21 to 24), a plurality of optical combiners (3) each having a plurality of input optical fiber transmission lines (31 to 34) and one output optical fiber transmission line (30), at least one of the output optical fiber transmission lines (23, 24) of at least one of the optical splitters having a free end and at least one of the input optical fiber transmission lines (33, 34) of at least one of the optical combiners having a free end.

The invention relates to methods of upgrading (rather than reconfiguring) optical transmission networks, associated upgradeable optical transmission networks intended to be upgraded by those upgrading methods, upgradeable optical transmission nodes intended to be upgraded by those upgrading methods, and upgraded optical transmission nodes that have been upgraded by those upgrading methods.

One prior art upgradeable optical transmission network comprises 2^{nd} degree optical transmission nodes that are based on the use of wavelength blockers and optical splitters consisting of 1-to-2 couplers and optical combiners consisting of 2-to-1 couplers and are subsequently upgraded to nodes of higher degree by cascading 1-to-2 couplers and 2-to-1 couplers in the optical splitters and the optical combiners, respectively. Examples of that type of prior art are described in U.S. Patent Application 2003/002104. Other types of nodes using optical splitters based on 1-to-2 couplers and optical combiners based on 2-to-1 couplers are described in European Patent Applications EP 1298467 and EP 1271827. Another type of node using optical splitters based on 1-to-3 couplers is described in the international patent application WO99/65165. None of the above examples of optical transmission nodes can be upgraded, for example to a higher degree, without interrupting traffic.

The invention proposes to provide an upgradeable optical transmission node having an optical transmission line at the output of at least one of its optical splitters that has a free end and an optical transmission line at the input of at least one of its optical combiners that has a free end. The optical transmission node can therefore be upgraded, for example to an optical transmission node of higher degree, without interrupting traffic simply by connecting the available and as yet unconnected free ends of the optical transmission lines to the new transmission direction that is to be added to the node; the free ends already available can be connected without interrupting traffic. Because the optical splitters have at least one more output optical transmission line than the prior art, their losses are higher; there are therefore additional losses compared to the prior art during operation before upgrading. The invention also relates to an upgradeable optical transmission network integrating at least one upgradeable node of the invention, to an upgrading method, and to an upgraded node.

The expression “connect to an entity” means providing a link to the entity to enable the transfer of data to and/or from that entity, whether directly or indirectly, i.e. via at least one optical transmission line and/or at least one component such as an amplifier, for example. The term “connection” has the same meaning. To be connected on the upstream side to an entity means to have a connection to the entity that enables the transfer of data from that entity, whether directly or indirectly, i.e. via at least one optical transmission line and/or at least one component such as an amplifier, for example. To be connected on the downstream side to an entity means to have a connection to the entity that enables the transfer of data to that entity, whether directly or indirectly, i.e. via at least one optical transmission line and/or at least one component such as an amplifier, for example.

The invention provides a method of upgrading an upgradeable wavelength division multiplex optical transmission network comprising a plurality of transmission directions, at least one upgradeable optical transmission node interconnecting at least some of said transmission directions and including a plurality of optical fiber transmission lines, a plurality of optical splitters each having one input optical fiber transmission line and a plurality of output optical fiber transmission lines, a plurality of optical combiners each having a plurality of input optical fiber transmission lines and one output optical fiber transmission line, at least one of the output optical fiber transmission lines of at least one of the optical splitters having an end that is not connected on the downstream side either to a transmission direction or to a drop device, if any, and at least one of the input optical fiber transmission lines of at least one of the optical combiners having an end that is not connected on the upstream side either to a transmission direction or to an add device, if any, the upgrading method comprising at least one step of connecting to said node or to at least one of said nodes at least one output optical fiber transmission line that is not connected on the downstream side and at least one input optical fiber transmission lines that is not connected on the upstream side either to a new transmission direction not yet connected to said node or respectively to a drop device, if any, and to an add device, if any, not yet connected to said node.

A function of the upgrading method is to upgrade an upgradeable optical transmission network, i.e. a network that has been designed to be upgraded by the above upgrading method. To be more precise, a function of the above upgrading method is to upgrade an optical transmission node, or advantageously a plurality of optical transmission nodes, of the optical transmission network, and where applicable all the optical transmission nodes of the optical transmission network. The optical transmission nodes are upgradeable, i.e. designed to be upgraded by the above upgrading method.

An optical transmission node interconnects a plurality of transmission directions and enables some or all of the transmission directions (preferably all of them) to exchange data unidirectionally (or preferably bidirectionally) with some or all of the other transmission directions (preferably with all of them).

To convey data, the optical transmission node comprises optical transmission lines, i.e. lines based on optical fibers, comprising one or more optionally-cabled optical fibers, possibly incorporated in one or more optical fiber cables, if they are cabled.

To enable the optical transmission node to switch data correctly, it includes a plurality of optical splitters and a plurality of optical combiners. An optical splitter separates or distributes data and therefore has a single input and several outputs. An optical combiner groups data together and therefore has a plurality of inputs and a single output.

For an optical transmission node to be able to evolve towards greater complexity without interrupting data traffic, at least one of the optical splitters has a free output, i.e. an output not yet connected on the downstream side to a transmission direction or to a drop device, i.e. a floating output, i.e. an output that is unused and unusable without modification, which modification consists precisely in connecting it either to a transmission direction or to a drop device during the connection step of the upgrading method. The free output is an initially unused output that is provided in advance so that it can simply be connected without interrupting traffic. The drawback of this is higher losses at the outset, which the inventors consider to be compensated by the possibility of simple and fast evolution, most importantly without interrupting traffic.

For an optical transmission node to be able to evolve toward greater complexity without interrupting data traffic, at least one of the optical combiners likewise has a free input, i.e. an input that is not yet connected on the upstream side to a transmission direction or to an add device, i.e. an input that is floating, i.e. an input that is unused and unusable without modification, which modification consists precisely in connecting it either to a transmission direction or to an add device during the connection step of the upgrading method. The free input is an initially unused input that is provided in advance so that it may simply be connected without interrupting traffic. Once again, the drawback is higher losses at the outset, which the inventors consider to be compensated by the possibility of simple and fast evolution, most importantly without interrupting traffic.

The evolution of the optical transmission node or nodes is preferably one of two kinds: either the degree of the node is increased, for example a 2^{nd} degree node becomes a 3^{rd} degree node, a 3^{rd} degree node becomes a 4^{th} degree node, or a 2^{nd} degree node becomes a 4^{th} degree node directly, or else an add and drop system comprising a drop device and an add device is added to the optical transmission node.

In the first type of evolution, to upgrade at least one node of degree N, where N is an integer greater than or equal to 2, to a node of degree N+P, where P is an integer greater than or equal to 1, during the connection step, there is added a new transmission direction not yet connected to said node, to which are connected at least one output optical fiber transmission line that is not connected on the downstream side and at least one input optical fiber transmission lines that is not connected on the upstream side. The degree of the optical transmission node is increased by at least one unit. The degree of the node corresponds to the number of transmission directions that are connected to the node. The transmission directions can be connected unidirectionally or bidirectionally to one or more transmission directions connected to the node, and all the transmission directions are preferably connected bidirectionally to all the other transmission directions connected to the node. N preferably has the value 2 or 3. P preferably has the value 1 or 2. For example, a 2^{nd} or 3^{rd} degree node has its degree increased to the 3^{rd} degree or the 4^{th} degree. When the degree of the node is increased, in addition to upgrading the node without interrupting traffic, the losses of the upgraded node are lower than following a conventional upgrade by cascading a plurality of 1-to-2 splitters and a plurality of 2-to-1 combiners. Nevertheless, the initial losses in the upgradeable node are greater, which is why the optical splitter to be upgraded is preferably at most a 1-to-4 splitter with at most two free outputs and the optical combiner to be upgraded is preferably at most a 4-to-1 combiner with at most two free inputs. To give an illustrative example, on evolving from a 2^{nd} degree node to a 3^{rd} degree node, the losses conventionally increase from 12 dB (corresponding to a combination comprising a 1-to-2 coupler followed by a wavelength blocker followed by a 2-to-1 coupler) to 24 dB (corresponding to two combinations of the above type in series), whereas, in the case of the invention, the losses amount to 16 dB, for example, corresponding to a 1-to-3 coupler followed by a wavelength blocker followed by a 3-to-1 coupler.

In the second type of evolution, at least one drop device and at least one add device are added during the connection step to which are respectively connected at least one output optical fiber transmission line that is not connected on the downstream side and at least one input optical fiber transmission lines that is not connected on the upstream side. The free transmission lines are used to add an add and drop facility at the node instead of to increase the degree of the node.

The invention also relates to an upgradeable network designed to be upgraded by the upgrading method of the invention. According to the invention, there is also provided an upgradeable wavelength division multiplex optical transmission network comprising: a plurality of transmission directions, at least one upgradeable optical transmission node interconnecting at least some of said transmission directions and including a plurality of optical fiber transmission lines, a plurality of optical splitters each having one input optical fiber transmission line and a plurality of output optical fiber transmission lines, and a plurality of optical combiners each having a plurality of input optical fiber transmission lines and one output optical fiber transmission line; the network is characterized in that at least one of said nodes further comprises at least one output optical fiber transmission line of at least one optical splitter which has an end that is not connected on the downstream side either to a transmission direction or to a drop device, if any, and at least one input optical fiber transmission line of at least one optical combiner which has an end that is not connected on the upstream side either to a transmission direction or to an add device, if any.

The invention further relates to an upgradeable node forming part of a upgradeable network designed to be upgradeable by the upgrading method of the invention. According to the invention, there is also provided an upgradeable optical transmission node including a plurality of optical fiber transmission lines, a plurality of optical splitters each having one input optical fiber transmission line and a plurality of output optical fiber transmission lines, and a plurality of optical combiners each having a plurality of input optical fiber transmission lines and one output optical fiber transmission line, which upgradeable optical transmission node is characterized in that at least one of the output optical fiber transmission lines of at least one of the optical splitters has a free end, and at least one of the input optical fiber transmission lines of at least one of the optical combiners has a free end.

The upgradeable node is preferably of the 2^{nd} or 3^{rd} degree, to limit the initial increase in losses during use of the node prior to upgrading.

All the upgradeable nodes are intended to be used before they are upgraded. The upgrading method is a method of upgrading nodes in operation and not merely a step in a method of installing a node that cannot be upgraded in use without interrupting traffic.

The node preferably has a plurality of output optical fiber transmission lines of at least one of the optical splitters each having a free end, and a plurality of input optical fiber transmission lines of at least one of the optical combiners each having a free end. Consequently, the node may undergo two or more evolutions without interrupting traffic.

The node preferably has a plurality of optical splitters each having at least one output optical fiber transmission line having a free end, and a plurality of optical combiners each having at least one input optical fiber transmission line having a free end. Thus a plurality of transmission directions can benefit from the evolution of the node.

All the optical splitters preferably have at least one output optical fiber transmission line having a free end, and all the optical combiners preferably have at least one input optical fiber transmission line having a free end. Thus all the transmission directions can benefit from the evolution of the node.

In one embodiment, the node is an optical cross-connect unit and the evolution can convert it into an add and drop optical multiplexer and/or increase its degree.

In another preferred embodiment, the node is an optical add and drop multiplexer (OADM) comprising at least one add device and at least one drop device. The optical add and drop multiplexer can be upgraded. Thus the evolution can add another add and drop function to it and/or increase its degree.

At least one of the optical splitters is preferably a wavelength switch. A plurality of optical splitters of the node and/or of the network are advantageously wavelength switches. It is even more advantageous if all the optical splitters of the node and/or of the network are wavelength switches.

At least one of the optical splitters of the node is preferably a coupler and at least one of the output optical fiber transmission lines of said coupler is preferably connected to a wavelength blocker. A plurality of optical splitters of the node and/or of the network are advantageously couplers to which wavelength blockers are added. It is even more advantageous if all the optical splitters of the node and/or of the network are couplers to which wavelength blockers are added.

At least one of the optical combiners of the node is preferably a wavelength switch. A plurality of optical combiners of the node and/or of the network are advantageously wavelength switches. It is even more advantageous if all the optical combiners of the node and/or of the network are wavelength switches.

At least one of the optical combiners of the node is preferably a coupler and at least one of the input optical fiber transmission lines of said coupler is preferably connected to a wavelength blocker. A plurality of optical combiners of the node and/or of the network are advantageously couplers to which wavelength blockers are added. It is even more advantageous if all the optical combiners of the node and/or of the network are couplers to which wavelength blockers are added.

The wavelength switch and the wavelength blocker can be reconfigured, i.e. their wavelength selectivity can be modified.

The node advantageously includes an amplifier on the upstream side of each optical splitter and an amplifier on the downstream side of each optical combiner. These amplifiers are two-stage amplifiers, for example, symbolized in the drawings by a double arrowhead, which also indicates the data transmission direction.

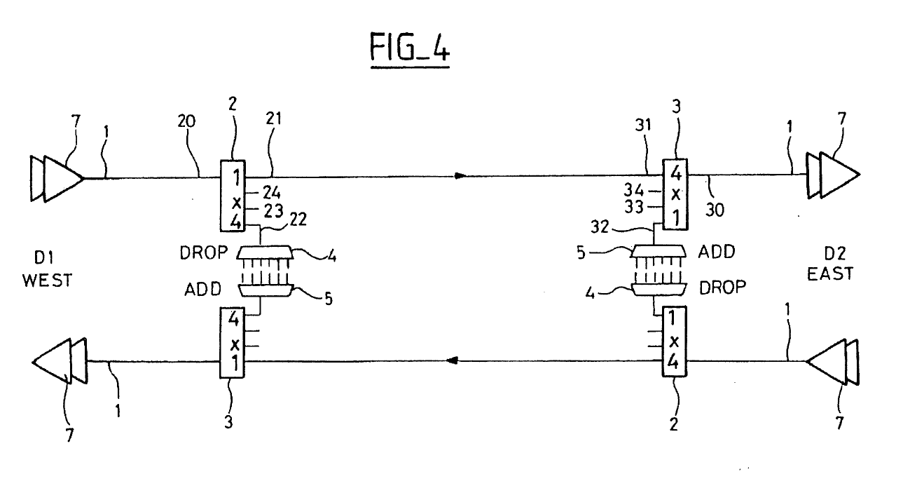

The invention also relates to an upgraded node of an upgraded network that has been upgraded by the upgrading method of the invention. According to the invention, there is also provided an N^{th} degree upgraded optical transmission node, where N is an integer greater than or equal to 3, including a plurality of optical fiber transmission lines, N optical splitters each having one input optical fiber transmission line and a plurality of output optical fiber transmission lines, and N optical combiners each having a plurality of input optical fiber transmission lines and one output optical fiber transmission line; the node is characterized in that it also includes N.(N−1) wavelength blockers, each wavelength blocker being situated between an output optical fiber transmission line of an optical splitter and an input optical fiber transmission line of an optical combiner. FIG. 4 shows an example of this kind of upgraded node for which N=3.

European Patent Application EP 1069720 and U.S. Patent Application 2004/131356, for example, disclose an optical transmission network comprising optical transmission nodes based on the use of optical splitters consisting of demultiplexers and other fixed passive optical components for which the spectral capacity at each output is fixed at installation time and can no longer be modified without interrupting traffic in the network and optical combiners consisting of multiplexers and other non-reconfigurable passive optical components for which the spectral capacity at each input is fixed at installation time and can no longer be modified. In that type of network, some optical splitters or combiners can have free pins for increasing capacity by adding wavelengths.

In contrast, no free pin is required for increasing the capacity by adding wavelengths in a preferred typical embodiment of a network of the invention using optical splitters and combiners that can be reconfigured without interrupting traffic and have at each of their outputs and inputs, respectively, a spectral capacity that is variable (i.e. wavelengths can be added or dropped) and that can be modified at the time of a reconfiguration (wavelengths can be redirected from one pin to another pin); however, to solve the problem that the invention specifically addresses, which does not arise in the above prior art, namely adding new transmission directions at one or more nodes in the network, the invention provides one or more free pins on these optical combiners and splitters, which free pins would not be required to solve a simple capacity problem. Accordingly, in a preferred embodiment of a network of the invention of this type, the optical combiners or at least some of them have input optical fiber transmission lines of variable spectral capacity that can be reconfigured without interrupting traffic and the optical splitters or at least some of them have output optical fiber transmission lines of variable spectral capacity that can be reconfigured without interrupting traffic. Typical examples of optical splitters and combiners of this kind are, firstly, wavelength switches and combinations of couplers and, secondly, wavelength blockers. Each of the above embodiments of the invention may be associated with this preferred embodiment of the optical combiners and splitters.

The invention will be more clearly understood and other features and advantages of the invention will become apparent in the light of the following description and the appended drawings, which are provided by way of example and in which:

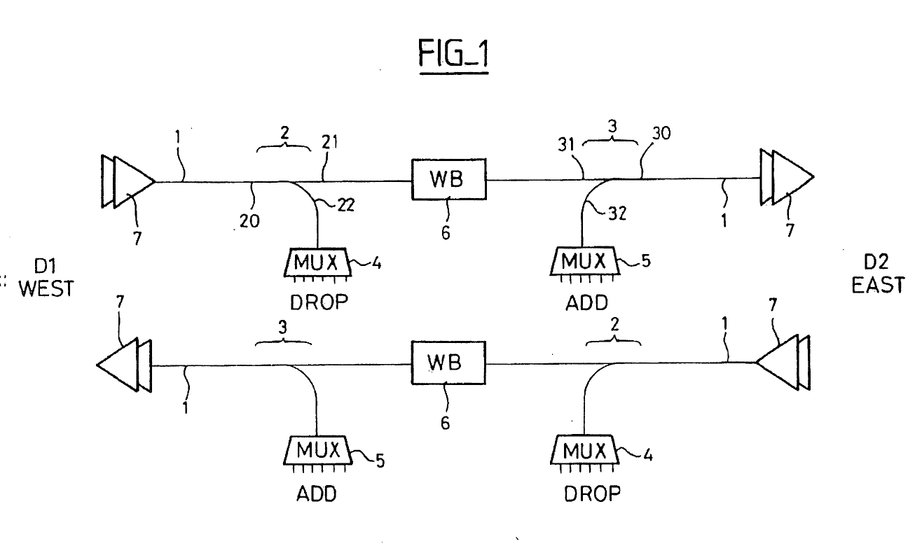

FIG. 1 is a diagram of a prior art 2^{nd} degree optical transmission node,

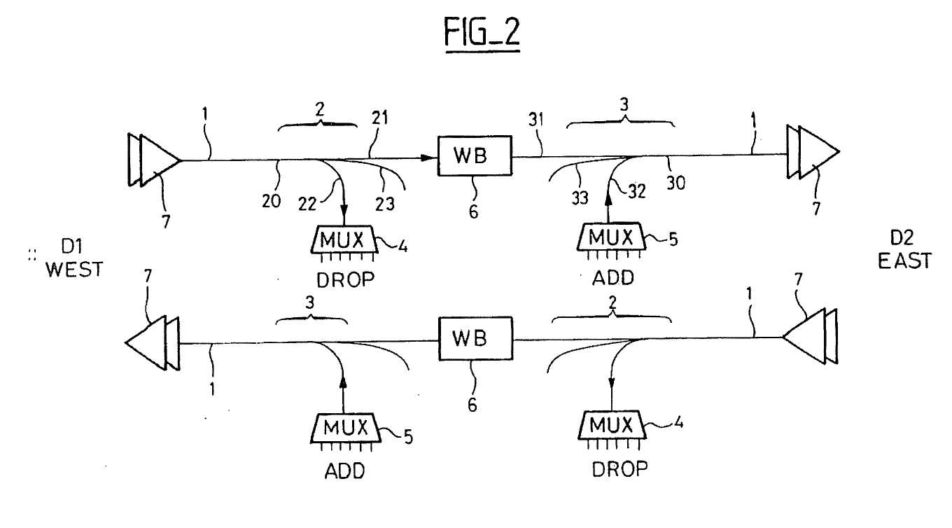

FIG. 2 is a diagram of a 2^{nd} degree optical transmission node of the invention that can be upgraded once by the upgrading method of the invention,

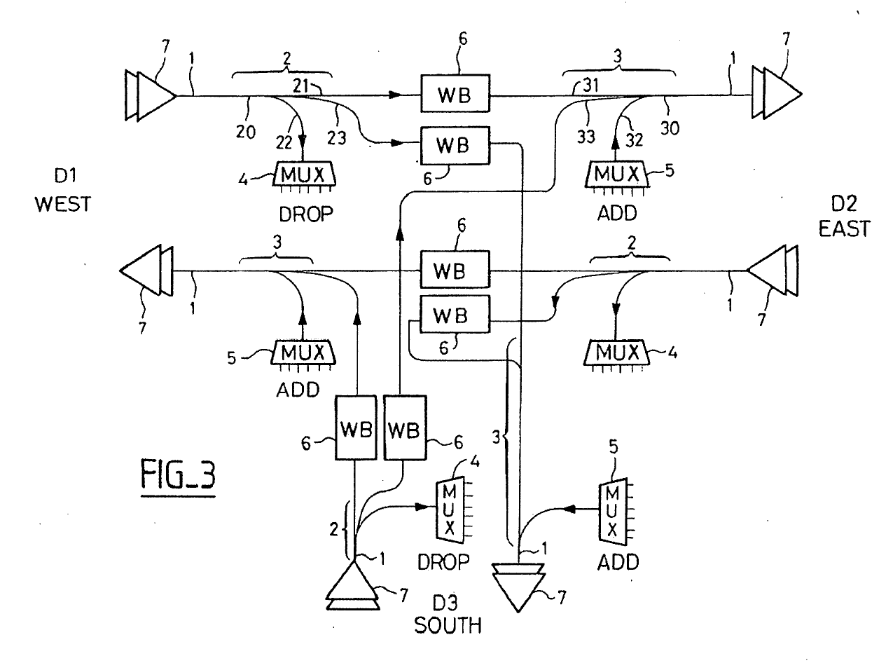

FIG. 3 is a diagram of a 3^{rd} degree optical transmission node of the invention that has been upgraded by the upgrading method of the invention,

FIG. 4 is a diagram of a 2^{nd} degree optical transmission node of the invention that can be upgraded twice by the upgrading method of the invention,

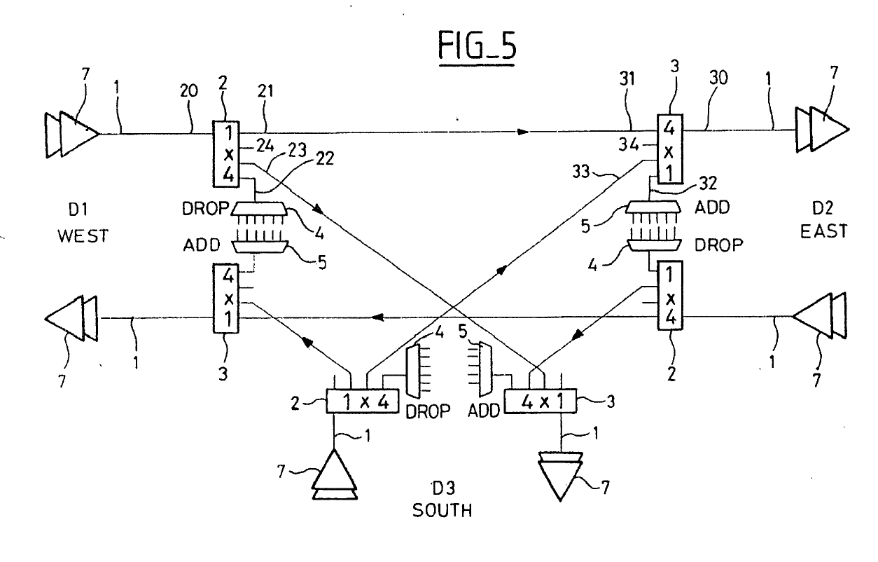

FIG. 5 is a diagram of a 3^{rd} degree optical transmission node of the invention that can be upgraded once by the upgrading method of the invention, and

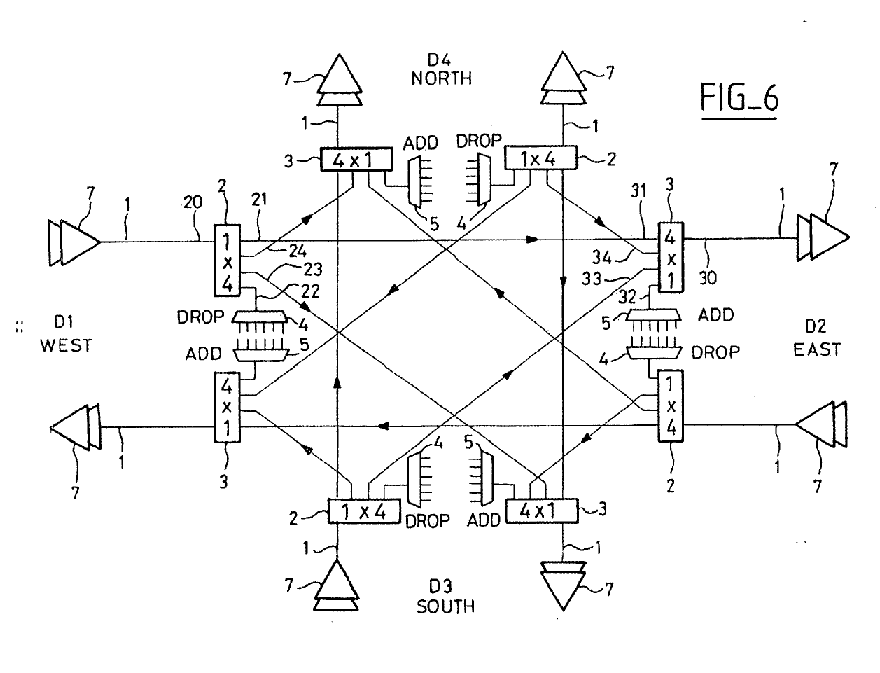

FIG. 6 is a diagram of a 4^{th} degree optical transmission node of the invention that has been upgraded by the upgrading method of the invention.

The following notation is used in all of FIGS. 1 to 6: The line 1 represents an optical transmission line. All inputs and outputs of the optical splitters and combiners are optical transmission lines. A black arrowhead on an optical transmission line indicates the data transmission direction, as does a white arrowhead 7 at the end of the optical transmission line, which symbolizes an amplifier. The uplink-to-downlink direction is the data transmission direction. Beyond the amplifiers 7, which are optional, and the two-stage implementation of which shown in the figures is also optional, are the transmission directions, comprising the transmission directions D1 (WEST) and D2 (EAST), and where applicable the transmission directions D3 (SOUTH) and/or D4 (NORTH). The node represented connects the transmission directions represented bidirectionally. Each optical splitter 2 has an input 20, an output 21, a drop output 22 directed to a drop device (MUX DROP) 4, and where applicable one or more other outputs 23 and/or 24. Each optical combiner 3 has an output 30, an input 31, an add input 32 directed to an add device (MUX ADD) 5, and where applicable one or more other inputs 33 and/or 34. To clarify the figures, each figure shows in detail only one optical splitter 2 and only one optical combiner 3. A free end is simply represented in the figures as floating, i.e. as not connected to any other component. In FIGS. 2 and 4, the output transmission line 23 has a free end, the other end being connected indirectly to the transmission direction D1. In FIGS. 3, 5 and 6, the output transmission line 23 has no free end, since one of its ends is connected indirectly to the transmission direction D1 and its other end is connected to the transmission direction D3. Each wavelength blocker (WB) 6 drops some of the spectral channels that pass through it and “blocks” certain wavelengths to enable them to be used again when adding new spectral channels on the downstream side without risk of collision.

FIGS. 4 to 6 show “1×4” optical splitters 2 and “4×1” optical combiners 3. Three embodiments are envisaged in practice. In a first embodiment, all the optical splitters 2 are couplers and all the optical combiners 3 are wavelength switches. In a second embodiment, all the optical splitters 2 are wavelength switches and all the optical combiners 3 are couplers. In a third embodiment, all the optical splitters 2 and all the optical combiners 3 are wavelength switches.

In an optical splitter, a coupler separates data received at the input into portions sent to respective outputs, each portion comprising all of the data but having an amplitude reduced relative to that of the data available at the input. In an optical splitter, a wavelength switch spectrally separates data received at the input into portions the correspond to spectrally different subdomains and are sent to respective outputs, each portion comprising only one spectral subdomain of the data. This spectral separation is not fixed and may be reconfigured.

In an optical combiner, a coupler groups together data received at the inputs to send it to the output. In an optical combiner, a wavelength switch at the output multiplexes data received at its inputs after the data has been spectrally filtered.

FIG. 1 is a diagram of a prior art 2^{nd} degree optical transmission node that connects two transmission directions D1 and D2 bidirectionally. Data arriving from the transmission direction D1, for example, passes through an amplifier 7 to an input 20 of an optical splitter 2 and passes through the optical splitter 2. The data is sent to an output 22 of the optical splitter 2 and is then dropped by a drop device 4. The data is sent to an output 21 of the optical splitter 2 and then passes through a wavelength blocker 6 to an input 31 of an optical combiner 3. Data added by an add device 5 reaches an input 32 of the optical combiner 3. Data received at the inputs 31 and 32 of the optical combiner 3 is grouped together at the output 30 of the optical combiner 3. The data sent to the output 30 of the optical combiner 3 passes through an amplifier 7 and exits to another transmission direction, here the transmission direction D2.

FIG. 2 is a diagram of a 2^{nd} degree optical transmission node of the invention that can be upgraded once by the upgrading method of the invention. The expression “can be upgraded once” means, in the case of increasing the degree of the node, that the degree may be increased by one unit, whether than evolution is effected only once or more than once. The node is of the 2^{nd} degree and connects two transmission directions D1 and D2 bidirectionally. Data arriving from the transmission direction D1, for example, passes through an amplifier 7 to an input 20 of an optical splitter 2 and passes through the optical splitter 2. The data is sent to an output 22 of the optical splitter 2 and is then dropped by a drop device 4. The data is sent to an output 21 of the optical splitter 2 and then passes through a wavelength blocker 6 to an input 31 of an optical combiner 3. The data is sent to an output 22 of the optical splitter 2 and is then dropped by a drop device 4. The data is sent to an output 23 of the optical splitter 2 where it is blocked because the output 23 is free on the downstream side, i.e. is not connected on the downstream side. The data is sent to an output 21 of the optical splitter 2 and then passes through a wavelength blocker 6 to an input 31 of an optical combiner 3. Data added by an add device 5 reaches an input 32 of the optical combiner 3. No data comes from the input 33 of the optical combiner, which input 33 is free on the upstream side, i.e. is not connected on the upstream side. Although here there is no data at the input 33, data received at the inputs 31, 32 and 33 of the optical combiner 3 is grouped together at the output 30 of the optical combiner 3. Data sent to the output 30 of the optical combiner 3 passes through an amplifier 7 before departing to another transmission direction, for example the transmission direction D2. The optical splitters 2 and the optical combiners 3 are couplers.

FIG. 3 is a diagram of a 3^{rd} degree optical transmission node of the invention that has been upgraded by the upgrading method of the invention. The node is of the 3^{rd} degree and connects three transmission directions D1, D2 and D3 bidirectionally. Data arriving from the transmission direction D1, for example, passes through an amplifier 7 to an input 20 of an optical splitter 2 and passes through the optical splitter 2. The data is sent to an output 22 of the optical splitter 2 and is then dropped by a drop device 4. The data is sent to an output 23 of the optical splitter 2, which output 23 has been connected to another transmission direction, for example to the transmission direction D3, via a wavelength blocker 6 and an optical combiner 3 during the connection step of the upgrading method. The data is sent to an output 21 of the optical splitter 2 and then passes through a wavelength blocker 6 to an input 31 of an optical combiner 3. Data added by an add device 5 reaches an input 32 of the optical combiner 3. Data reaches the input 33 of the optical combiner 3 from another transmission direction, for example the transmission direction D3, said input 33 having been connected to the transmission direction D3 via a wavelength blocker 6 and an optical splitter 2 during the connection step of the upgrading method. Data received at the inputs 31, 32 and 33 of the optical combiner 3 is grouped together at the output 30 of the optical combiner 3. Data sent to the output 30 of the optical combiner 3 passes through an amplifier 7 before departing to another transmission direction, for example the transmission direction D2. The 3^{rd} degree node includes three optical splitters 2, three optical combiners 3, and six wavelength blockers 6. The optical splitters 2 and the optical combiners 3 are couplers.

FIG. 4 is a diagram of a 2^{nd} degree optical transmission node of the invention that can be upgraded twice by the upgrading method of the invention. The node is of the 2^{nd} degree and connects two transmission directions D1 and D2 bidirectionally. Data arriving from the transmission direction D1, for example, passes through an amplifier 7 to an input 20 of an optical splitter 2 and passes through the optical splitter 2. Depending on whether the optical splitter 2 is respectively a coupler or a wavelength switch, all or some of the data is sent to an output 22 of the optical splitter 2 and is then dropped by a drop device 4. Depending on whether the optical splitter 2 is respectively a coupler or a wavelength switch, all or some of the data is sent to an output 23 of the optical splitter 2, where it is blocked since the output 23 is free on the downstream side, i.e. is not connected on the downstream side. Depending on whether the optical splitter 2 is respectively a coupler or a wavelength switch, all or some of the data is sent to an output 24 of the optical splitter 2, where it is blocked since the output 24 is free on the downstream side, i.e. is not connected on the downstream side. Depending on whether the optical splitter 2 is respectively a coupler or a wavelength switch, all or some of the data is sent to an output 21 of the optical splitter 2 and then reaches an input 31 of an optical combiner 3. Data added by an add device 5 reaches an input 32 of the optical combiner 3. No data comes from the input 33 of the optical combiner 3, which input 33 is free on the upstream side, i.e. is not connected on the upstream side. No data comes from the input 34 of the optical combiner 3, which input 34 is free on the upstream side, i.e. is not connected on the upstream side. Although there is no data at the inputs 33 and 34, data received at the inputs 31, 32, 33 and 34 of the optical combiner 3 is combined together at the output 30 of the optical combiner 3. Data sent to the output 30 of the optical combiner 3 passes through an amplifier 7 before departing to another transmission direction, for example the transmission direction D2.

FIG. 5 is a diagram of a 3^{rd} degree optical transmission node of the invention that can be upgraded once by the upgrading method of the invention. FIG. 5 also corresponds to the FIG. 4 transmission node when it has been upgraded once. The node is of the 3^{rd} degree and connects three transmission directions D1, D2 and D3 bidirectionally. Data arriving from the transmission direction D1, for example, passes through an amplifier 7 to an input 20 of an optical splitter 2 and passes through the optical splitter 2. Depending on whether the optical splitter 2 is respectively a coupler or a wavelength switch, all or some of the data is sent to an output 22 of the optical splitter 2 and is then dropped by a drop device 4. Depending on whether the optical splitter 2 is respectively a coupler or a wavelength switch, all or some of the data is sent to an output 23 of the optical splitter 2, which output 23 has been connected to another transmission direction, for example the transmission direction D3, via an optical combiner 3 during the connection step of the upgrading method. Depending on whether the optical splitter 2 is respectively a coupler or a wavelength switch, all or some of the data is sent to an output 24 of the optical splitter 2, where it is blocked since the output 24 is free on the downstream side, i.e. is not connected on the downstream side. Depending on whether the optical splitter 2 is respectively a coupler or a wavelength switch, all or some of the data is sent to an output 21 of the optical splitter 2 and reaches an input 31 of an optical combiner 3. Data added by an add device 5 reaches an input 32 of the optical combiner 3. Data reaches the input 33 of the optical combiner 3 from another transmission direction, for example the transmission direction D3, said input 33 having been connected to the transmission direction D3 via an optical splitter 2 during the connection step of the upgrading method. No data comes from the input 34 of the optical combiner 3, which input 34 is free on the upstream side, i.e. is not connected on the upstream side. Although here there is no data at the input 34, data received at the inputs 31, 32, 33 and 34 of the optical combiner 3 is combined together at the output 30 of the optical combiner 3. Data sent to the output 30 of the optical combiner 3 passes through an amplifier 7 before departing to another transmission direction, for example the transmission direction D2.

FIG. 6 is a diagram of one example of a 4^{th} degree optical transmission node that has been upgraded by the upgrading method of the invention. FIG. 6 also corresponds to a FIG. 5 transmission node that has been upgraded once or to a FIG. 4 transmission node that has been upgraded twice. The node is of the 4^{th} degree and connects four transmission directions D1, D2, D3 and D4 bidirectionally. Data arriving from the transmission direction D1, for example, passes through an amplifier 7 to an input 20 of an optical splitter 2 and passes through the optical splitter 2. Depending on whether the optical splitter 2 is respectively a coupler or a wavelength switch, all or some of the data is sent to an output 22 of the optical splitter 2 and is then dropped by a drop device 4. Depending on whether the optical splitter 2 is respectively a coupler or a wavelength switch, all or some of the data is sent to an output 23 of the optical splitter 2, which output 23 has been connected to another transmission direction, for example the transmission direction D3, via an optical combiner 3 during the connection step of the upgrading method. Depending on whether the optical splitter 2 is respectively a coupler or a wavelength switch, all or some of the data is sent to an output 24 of the optical splitter 2, which output 24 has been connected to another transmission direction, for example the transmission direction D4, via an optical combiner 3 during the connection step of the upgrading method. Depending on whether the optical splitter 2 is respectively a coupler or a wavelength switch, all or some of the data is sent to an output 21 of the optical splitter 2 and then reaches an input 31 of an optical combiner 3. Data added by an add device 5 reaches an input 32 of the optical combiner 3. Data reaches the input 33 of the optical combiner 3 from another transmission direction, for example the transmission direction D3, said input 33 having been connected to the transmission direction D3 via an optical splitter 2 during the connection step of the upgrading method. Data reaches the input 34 of the optical combiner 3 from another transmission direction, for example the transmission direction D4, said input 34 having been connected to the transmission direction D4 via an optical splitter 2 during the connection step of the upgrading method. Data received at the inputs 31, 32, 33 and 34 of the optical combiner 3 is combined together at the output 30 of the optical combiner 3. Data sent to the output 30 of the optical combiner 3 passes through an amplifier 7 before departing to another transmission direction, for example the transmission direction D2.

In all of the figures, if a new transmission direction is connected to the node, it can be connected without interrupting communication between the transmission directions already connected to the node.

1. A method of upgrading an upgradeable wavelength division multiplex optical transmission network comprising:
a plurality of transmission directions (D1 to D4);
at least one upgradeable optical transmission node interconnecting at least some of said transmission directions and including:
a plurality of optical fiber transmission lines;
a plurality of optical splitters (2) each having one input optical fiber transmission line (20) and a plurality of output optical fiber transmission lines (21 to 24), at least one of the output optical fiber transmission lines (23, 24) of at least one of the optical splitters having an end that is not connected on the downstream side either to a transmission direction or to a drop device, if any;
a plurality of optical combiners (3) each having a plurality of input optical fiber transmission lines (31 to 34) and one output optical fiber transmission line (30), at least one of the input optical fiber transmission lines (33, 34) of at least one of the optical combiners having an end that is not connected on the upstream side either to a transmission direction or to an add device, if any;
the upgrading method comprising at least one step of connecting to said node or to at least one of said nodes at least one output optical fiber transmission line (23, 24) that is not connected on the downstream side and at least one input optical fiber transmission line (33, 34) that is not connected on the upstream side either to a new transmission direction not yet connected to said node or respectively to a drop device, if any, and to an add device, if any, not yet connected to said node.

2. An upgrading method according to claim 1, characterized in that, to upgrade at least one node of degree N, where N is an integer greater than or equal to 2, to a node of degree N+P, where P is an integer greater than or equal to 1, during the connection step, there is added a new transmission direction (D3, D4) not yet connected to said node, to which there are connected at least one output optical fiber transmission line (23, 24) that is not connected on the downstream side and at least one input optical fiber transmission line (33, 34) that is not connected on the upstream side.

3. An upgrading method according to claim 2, characterized in that N has the value 2 or 3.

4. An upgrading method according to claim 2, characterized in that P has the value 1 or 2.

5. An upgrading method according to claim 1, characterized in that, during the connection step, there are added at least one drop device (4) and at least one add device (5) to which are respectively connected at least one output optical fiber transmission line (23, 24) that is not connected on the downstream side and at least one input optical fiber transmission line (33, 34) that is not connected on the upstream side.

6. An upgradeable wavelength division multiplex optical transmission network comprising:
a plurality of transmission directions (D1 to D4);
at least one upgradeable optical transmission node interconnecting at least some of said transmission directions and including:
a plurality of optical fiber transmission lines;
a plurality of optical splitters (2) each having one input optical fiber transmission line (20) and a plurality of output optical fiber transmission lines (21 to 24); and
a plurality of optical combiners (3) each having a plurality of input optical fiber transmission lines (31 to 34) and one output optical fiber transmission line (30);
which network is characterized in that at least one of said nodes further comprises:
at least one of the output optical fiber transmission lines (23, 24) of at least one of the optical splitters which has an end that is not connected on the downstream side either to a transmission direction or to a drop device, if any; and
at least one of the input optical fiber transmission lines (33, 34) of at least one of the optical combiners which has an end that is not connected on the upstream side either to a transmission direction or to an add device, if any.

7. An upgradeable optical transmission node including:
a plurality of optical fiber transmission lines;
a plurality of optical splitters (2) each having one input optical fiber transmission line (20) and a plurality of output optical fiber transmission lines (21 to 24); and
a plurality of optical combiners (3) each having a plurality of input optical fiber transmission lines (31 to 34) and one output optical fiber transmission line (30);
which node is characterized in that:
at least one of the output optical fiber transmission lines (23, 24) of at least one of the optical splitters has a free end; and
at least one of the input optical fiber transmission lines (33, 34) of at least one of the optical combiners has a free end.

8. An upgradeable node according to claim 7, characterized in that the node is of the 2^{nd} or 3^{rd} degree.

9. An upgradeable node according to claim 8, characterized in that it includes:
output optical fiber transmission lines (23, 24) of at least one of the optical splitters having a free end; and
input optical fiber transmission lines (33, 34) of at least one of the optical combiners having a free end.

10. An upgradeable node according to claim 7, characterized in that it includes:
optical splitters having at least one output optical fiber transmission line having a free end; and
optical combiners having at least one input optical fiber transmission line having a free end.

11. An upgradeable node according to claim 10, characterized in that:
all the optical splitters have at least one output optical fiber transmission line having a free end; and
all the optical combiners have at least one input optical fiber transmission line having a free end.

12. An upgradeable node according to claim 7, characterized in that it is an optical cross-connect unit.

13. An upgradeable node according to claim 7, characterized in that it is an optical add and drop multiplexer comprising at least one add device (5) and at least one drop device (4).

14. An upgradeable node according to claim 7, characterized in that at least one of the optical splitters is a wavelength switch.

15. An upgradeable node according to claim 7, characterized in that at least one of the optical splitters is a coupler and at least one of the output optical fiber transmission lines (21) of said coupler is connected to a wavelength blocker (6).

16. An upgradeable node according to claim 7, characterized in that at least one of the optical combiners is a wavelength switch.

17. An upgradeable node according to claim 7, characterized in that at least one of the optical combiners is a coupler and at least one of the input optical fiber transmission lines (31) of said coupler is connected to a wavelength blocker (6).

18. An upgradeable node according to claim 7, characterized in that it includes an amplifier (7) on the upstream side of each optical splitter and an amplifier (7) on the downstream side of each optical combiner.

19. An N h degree upgraded optical transmission node, where N is an integer greater than or equal to 3, including:
a plurality of optical fiber transmission lines;
N optical splitters (2) each comprising a coupler having one input optical fiber transmission line (20) and a plurality of output optical fiber transmission lines (21 to 24); and
N optical combiners (3) each comprising a coupler having a plurality of input optical fiber transmission lines (31 to 34) and one output optical fiber transmission line (30);
the node being characterized in that it also includes:
N.(N−1) wavelength blockers (6), each wavelength blocker being situated between an output optical fiber transmission line of an optical splitter and an input optical fiber transmission line of an optical combiner.

20. A method of upgrading an upgradeable wavelength division multiplex optical transmission network comprising:
a plurality of transmission directions (D1 to D4);
at least one upgradeable optical transmission node interconnecting at least some of said transmission directions and including:
a plurality of optical fiber transmission lines;
a plurality of optical splitters (2) each having one input optical fiber transmission line (20) and a plurality of output optical fiber transmission lines (21 to 24) of variable spectral capacity and that can be reconfigured without interrupting traffic, at least one of the output optical fiber transmission lines (23, 24) of at least one of the optical splitters having an end that is not connected on the downstream side either to a transmission direction or to a drop device, if any; and
a plurality of optical combiners (3) each having a plurality of input optical fiber transmission lines (31 to 34) of variable spectral capacity and that can be reconfigured without interrupting traffic and one output optical fiber transmission line (30), at least one of the input optical fiber transmission lines (33, 34) of at least one of the optical combiners having an end that is not connected on the upstream side either to a transmission direction or to an add device, if any;
the upgrading method comprising at least one step of connecting to said node or to at least one of said nodes at least one output optical fiber transmission line (23, 24) that is not connected on the downstream side and at least one input optical fiber transmission line (33, 34) that is not connected on the upstream side either to a new transmission direction not yet connected to said node or respectively to a drop device, if any, and to an add device, if any, not yet connected to said node.

21. An upgradeable wavelength division multiplex optical transmission network comprising:
a plurality of transmission directions (D1 to D4); and
at least one upgradeable optical transmission node interconnecting at least some of said transmission directions and including:
a plurality of optical fiber transmission lines;
a plurality of optical splitters (2) each having one input optical fiber transmission line (20) and a plurality of output optical fiber transmission lines (21 to 24) of variable spectral capacity and that can be reconfigured without interrupting traffic; and
a plurality of optical combiners (3) each having a plurality of input optical fiber transmission lines (31 to 34) of variable spectral capacity and that can be reconfigured without interrupting traffic and one output optical fiber transmission line (30);
which network is characterized in that at least one of said nodes further comprises:
at least one of the output optical fiber transmission lines (23, 24) of at least one of the optical splitters which has an end that is not connected on the downstream side either to a transmission direction or to a drop device, if any; and
at least one of the input optical fiber transmission lines (33, 34) of at least one of the optical combiners which has an end that is not connected on the upstream side either to a transmission direction or to an add device, if any.

22. An upgradeable optical transmission node comprising:
a plurality of optical fiber transmission lines;
a plurality of optical splitters (2) each having one input optical fiber transmission line (20) and a plurality of output optical fiber transmission lines (21 to 24) of variable spectral capacity and that can be reconfigured without interrupting traffic; and
a plurality of optical combiners (3) each having a plurality of input optical fiber transmission lines (31 to 34) of variable spectral capacity and that can be reconfigured without interrupting traffic and one output optical fiber transmission line (30);
which node is characterized in that:
at least one of the output optical fiber transmission lines (23, 24) of at least one of the optical splitters has a free end; and
at least one of the input optical fiber transmission lines (33, 34) of at least one of the optical combiners has a free end.
